(19) United States
(12) Patent Application Publication
(10) Pub. No.: US 2009/0223361 A1
(43) Pub. Date: Sep. 10, 2009

(54) FLUID PRESSURE TYPE ACTUATOR AND EXERCISE DEVICE USING THE SAME

(76) Inventors: Taisuke Matsushita, Tokyo (JP); Yutaka Sato, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/093,148

(22) PCT Filed: Nov. 9, 2006
(86) PCT No.: PCT/JP2006/322342

§ 371 Date: May 9, 2008

(30) Foreign Application Priority Data
Nov. 15, 2005 (JP) 2005-330271

(51) Int. Cl. F15B 15/10; B25J 19/00

(52) U.S. Cl. 92/92; 601/23

(57) ABSTRACT

A fluid pressure type actuator revolvable at high speeds and an exercise device using the actuator.

The fluid pressure type actuator comprises an expansible/contractible body (1), which is sealed by plug members (2,3) at both ends and expanded and contracted by the supply and discharge of a fluid there to and therefrom, a net-like wrapping body (7) which wraps the outside of the expansible/contractible body (1) and is fastened and secured to the plug members (2,3) at both ends, and inlet and outlet for fluid formed in the plug members (2,3).

It is characterized in having space reducing bodies (4,5) for filling at least a part of a space in the expansible/contractible body (1).

### TECHNICAL FIELD

The present invention relates to a fluid pressure type actuator driven by supply and discharge of fluid such as air, and an exercise device using the same.

### BACKGROUND ART

In the conventional fluid pressure type actuator, the outer periphery of the rubber tube is covered with a non-elastic net-like covering body, and the diameter of the covering body is increased by expansion of the tube by the air supply. The increment of the covering body reduces its length, and driving force is generated by the reduction (for example, refer to Patent Document 1).

Patent Document 1: JP-A-2003-301807

In the above-described conventional fluid pressure type actuator, since there is an extra space in the tube before supplying air, the air had to be supplied even for the extra space to expand the tube. Therefore it took some time from supplying air into the tube until the actual time that the actuator started operating. For example, in the case that the fluid pressure type actuator is applied to the CPM device (exercise device), it often takes about a minute from starting up the device to the actual start of movement to the joint of the patient, thus there has been a demand for improvement in operation speed of the actuator.

The objective of the present invention is to provide a fluid pressure type actuator and an exercise device using the same capable of addressing the above-mentioned need and improving the operation speed thereof.

### DISCLOSURE OF THE INVENTION

### Problems to be Solved

In order to achieve the above-mentioned objective, the fluid pressure type actuator comprises:

an expansible/contractible body which is sealed by plug members at both ends, and expanded and contracted by supply/discharge of a fluid thereto and therefrom;

a net-like wrapping body which wraps the outside of the expansible/contractible body and is fastened and secured to the plug members at both ends; and

an inlet/outlet for fluid formed in the plug members,

characterized in having a space reducing bodies for filling at least a part of a space in the expansible/contractible body. Also, the above-mentioned space reducing body placed in the expansible/contractible body is formed by a first space reducing body and a second space reducing body, the first space reducing body and the second reducing body are respectively coupled to the plug members, and are arranged in longitudinal direction of the above-mentioned expansible/contractive body leaving a space between each other. Cross-sectional area of the first space reducing body and the second space reducing body is gradually reduced from the rear-anchor part toward the end part. The end part of the first space reducing body and the second space reducing body are formed having spherical surface. The length that the expansible/contractible body expands and contracts equals the length between the first space reducing body and the second space reducing body.

Also, an exercise device of the present invention comprises:

a first frame body;

a second frame body which is revolvable with respect to the first frame body; and

the above-mentioned fluid pressure type actuator for causing the second frame body to relatively move with respect to the first frame body,

characterized in causing a part of a human body to perform exercise by moving the second frame body with respect to the first frame body.

### BRIEF DESCRIPTION OF THE DIAGRAMS

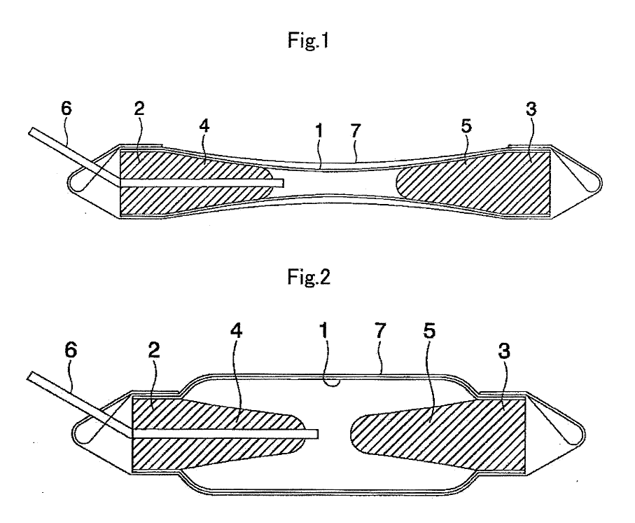

FIG. 1 is a cross-section showing the contracted condition of the fluid pressure type actuator by embodiment 1 of the present invention.

FIG. 2 is a cross-section showing the expanded condition of the fluid pressure type actuator in FIG. 1.

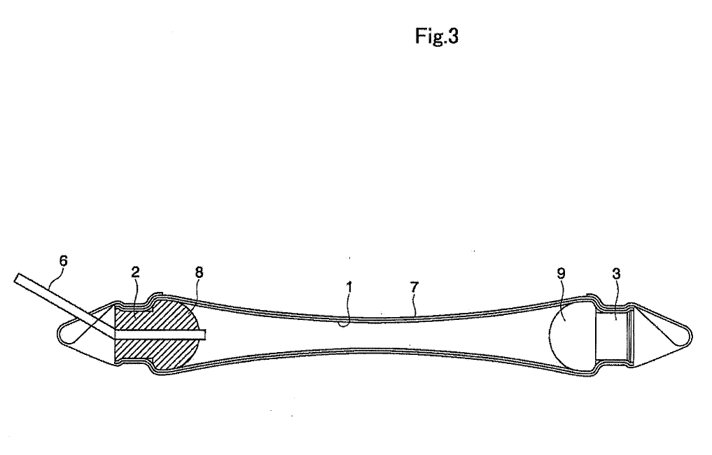

FIG. 3 is a cross-section showing the contracted condition of the fluid pressure type actuator by embodiment 2 of the present invention.

FIG. 4 is a cross-section showing the contracted condition of the fluid pressure type actuator by embodiment 3 of the present invention.

FIG. 5 is a cross-section showing the contracted condition of the fluid pressure type actuator by embodiment 4 of the present invention.

FIG. 6 is a cross-section showing the contracted condition of the fluid pressure type actuator by embodiment 5 of the present invention.

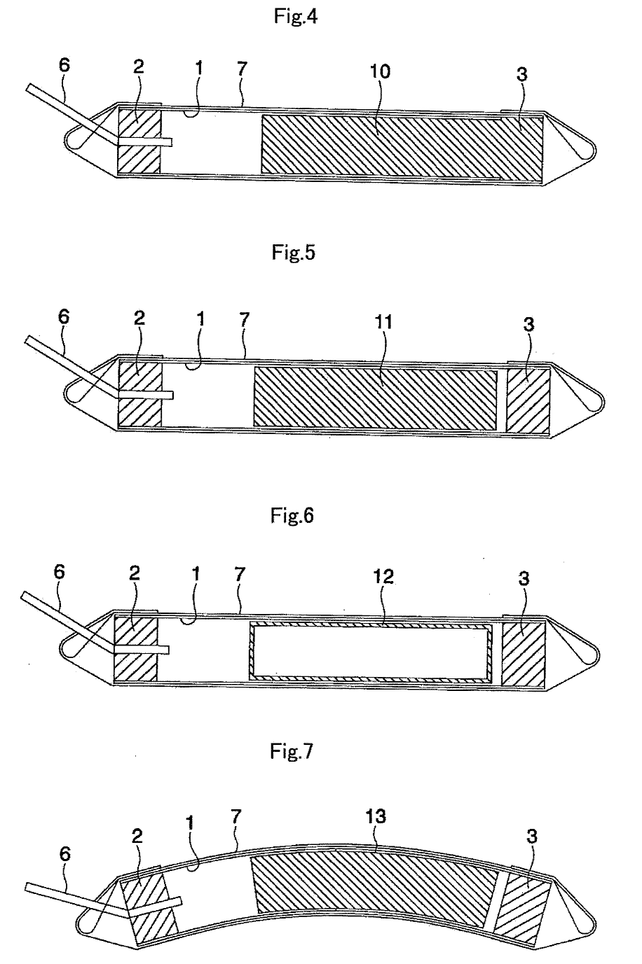

FIG. 7 is a cross-section showing the contracted condition of the fluid pressure type actuator by embodiment 6 of the present invention.

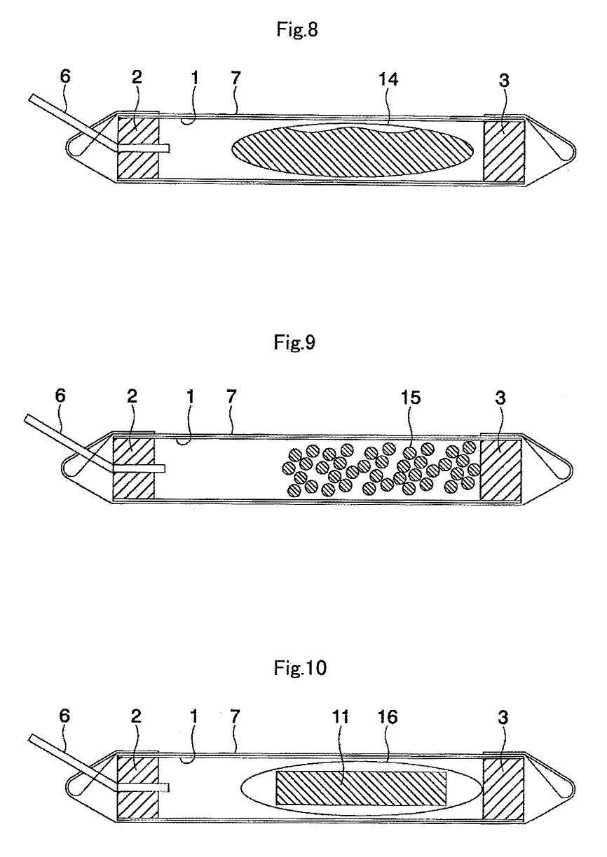

FIG. 8 is a cross-section showing the contracted condition of the fluid pressure type actuator by embodiment 7 of the present invention.

FIG. 9 is a cross-section showing the contracted condition of the fluid pressure type actuator by embodiment 8 of the present invention.

FIG. 10 is a cross-section showing the contracted condition of the fluid pressure type actuator by embodiment 9 of the present invention.

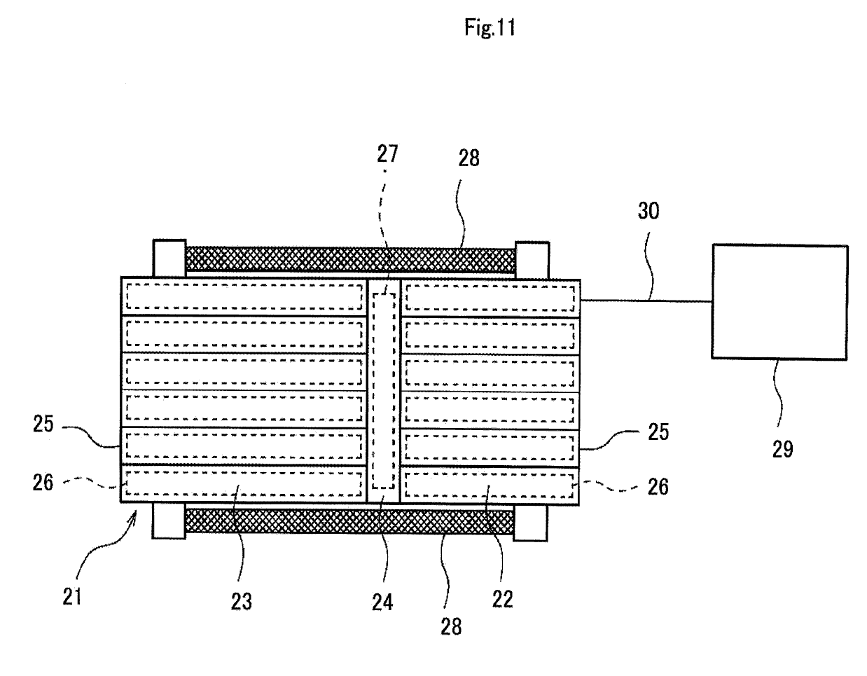

FIG. 11 shows the exercise device related to the present invention.

### BEST MODE FOR CARRYING OUT THE INVENTION

Hereinafter, the best mode for carrying out the invention will be described referring to the diagrams.

### Embodiment 1

FIG. 1 is a cross-section showing the contracted condition of an inner tube 1 of the fluid pressure type actuator by embodiment 1 of the present invention, and FIG. 2 is a cross-section showing the expanded condition of the inner tube 1 of the fluid pressure type actuator in FIG. 1. In the diagrams, both ends of the inner tube 1 as the expansible/contractible body are sealed by a first rubber plug 2 and a second rubber plug 3 that are cross-sectional circular shape. At least one of the rubber plugs 2 and 3 has an inlet/outlet for fluid. The inner tube 1 is formed by an elastic body such as Butyl-rubber.

A first space reducing body 4 is provided being integrated with the first rubber plug 2, and the second space reducing body 5 is provided being integrated with the second rubber plug 3. The first and second space reducing bodies 4 and 5 are positioned in the inner tube 1, and reduce the space in the inner tube upon contraction by filling a part of the space in the inner tube 1. In other words, the space reducing bodies 4 and 5 reduce the substantial inner volume of the inner tube 1 upon contraction.

Also, the first and second space reducing bodies 4 and 5 are arranged in long-axis direction of the inner tube 1 leaving space between each other, so as to avoid touching each other upon contraction of the actuator. Further, cross-sectional area of the first and the second space reducing bodies 4 and 5 are gradually reduced from the rear anchor part toward the end part. Accordingly, the inner tube 1 follows the shape of the space reducing body 11 upon contraction of the inner tube 1, and the space in the center part of the inner tube 1 can be reduced.

Also, the end of the space reducing bodies 4 and 5 are formed having spherical surface. Thus damaging of the inner tube due to the inner tube 1 and the space reducing body 11 touching each other can be prevented.

An aeration/exhaust tube 6 for supplying/discharging air as a fluid to/from the inner tube 1 is inserted through the first rubber plug 2. An air supply/discharge device (now shown) is being connected to the aeration/exhaust tube 6.

The outer periphery of the inner tube 1 is covered by a mesh sleeve 7 that is a net-like covering body. The mesh sleeve 7 is made of a wire rod such as high-tension fiber. Both ends of the inner tube 1 and the mesh sleeve 7 in longitudinal direction are respectively overlapped, held tightly and secured by a plurality of fastenings (not shown) and the rubber plugs 2 and 3.

In such fluid pressure type actuator, the inner tube 1 is expanded by supply of compressed air to the inner tube 1, but the material of the mesh sleeve 7 does not get elongated, and the increment of the diameter of the inner tube 1 is converted into the reduction of the overall length of the fluid pressure type actuator. Also, the diameter of the inner tube 1 gets smaller by discharge of air from the inner tube 1, and the overall length of the fluid pressure type actuator turns back.

By supplying fluid to the inner tube 1, the pressure in the inner tube is evenly increased, whereby expanding the inner tube 1. Also, by discharging fluid from the inner tube 1, the pressure in the inner tube 1 is evenly reduced, whereby contracting the inner tube 1.

At this time, since the space reducing bodies 4 and 5 are provided in the inner tube 1, the inner volume needing the increase/decrease of the pressure in the inner tube can be reduced, whereby enabling reduction of the quantity of fluid to be supplied/discharged to/from the inner tube 1. As a result, it is possible to reduce the time necessary for increasing the pressure in the inner tube 1 upon starting up the device, whereby speeding up the operation of the fluid pressure type actuator. Also, quantity of the fluid necessary for the operation can be reduced, whereby enabling minimization of the size of the compressor and reduction the electric power consumption.

For example, since the contraction amount of the revolvable part in the axis direction of the fluid pressure type actuator is equivalent to about 30% of the entire revolvable part when compressed air is fully supplied in the inner tube 1, if the total length of the space reducing bodies 4 and 5 in the axis direction is set at the length that is equivalent to about 70% of the moving part, the first and the second space reducing bodies 4 and 5 do not interfere with each other upon expansion of the inner tube 1. In this way, the quantity of compressed air necessary for driving the actuator can be reduced by about 70% compared to the conventional method.

Also, the length of the inner tube 1 may be set so that the inner tube reaches the position wherein the space reducing bodies 4 and 5 touch the inner tube 1 when compressed air is fully supplied to the inner tube 1. In concrete terms, assuming that the entire length of the fluid pressure type actuator contracts by 3 cm due to the expansion of the inner tube 1, the length of the inner tube 1 is to be set so that the interval between the space reducing body 4 and the space reducing body 5 upon contraction condition of the fluid pressure type actuator turns out to be 3 cm. In other words, the length that the inner tube 1 is in contracted condition and the length between the space reducing body 4 and the space reducing body 5 in expanded condition are the same.

Since the outer shape of the space reducing bodies 4 and 5 are tapered in conformity with the shape of the inner tube 1 in contracted condition, the space of the inner tube 1 can be efficiently filled without interfering with the contraction of the inner tube 1. Further, since the space reducing bodies 4 and 5 are formed being integrated with the rubber plugs 2 and 3, it is possible to prevent the increase of the number of components. Moreover, by making the outer shape of the first and the second space reducing bodies 4 and 5 the same, they can be manufactured using the same metal mold, whereby facilitating cost containment.

### Embodiment 2

Next, FIG. 3 is a cross-sectional view showing the contracted condition of the inner tube 1 of the fluid pressure type actuator by embodiment 2 of the present invention. A semispherical first and a second space reducing bodies 8 and 9 are provided by respectively integrating with the first and the second rubber plugs 2 and 3 (the second rubber plug 3 and the second space reducing body 9 indicate their side views in the diagram, not the cross-sections). The other configuration and operation are the same as the embodiment 1.

While the inner tube 1 has contractility, the first and the second rubber plugs 2 and 3 at both ends of the fluid pressure type actuator do not have the contractility, thus the inner tube 1 of the fluid pressure type actuator is concave toward the inner side upon contraction. Due to unnecessary space formed in the vicinity of both ends of the fluid pressure type actuator, it has been taking longer time to raise the pressure by just that much. In this embodiment, since the space is filled by the semispherical first and second space reducing bodies 8 and 9, the area necessary for increasing/decreasing the pressure in the inner tube 1 can be reduced. This causes the amount of fluid supplied/discharged to/from the inner tube to be reduced. Therefore, the time necessary for raising the pressure in the inner tube 1 can be shortened, whereby making it possible to speeding up the operation of the fluid pressure type actuator.

In this way, factors such as shape, size or protrusion amount toward the inside of the inner tube 1 of the space reducing bodies 8 and 9 do not have to be specifically limited, and the time necessary for raising the pressure in the inner tube upon start-up period can be shortened and speeding-up of the operation can be performed even by the space reducing bodies 8 and 9 shown in FIG. 3.

### Embodiment 3

FIG. 4 is a cross-section showing the fluid pressure type actuator by embodiment 3 of the present invention. On the second rubber plug 3, a rod-like space reducing body 10 having a cross-sectional circular shape is provided being integrated with it. Also, the space reducing body is not provided to the first rubber plug 2. The other configuration and operation are the same as embodiment 1.

In this way, the space reducing body 10 may be provided only to one rubber plug 3, thus the time required for raising the pressure in the inner tube 1 can be reduced, whereby speeding up the operation of the actuator. In addition, in the case of providing the space reducing body to the plug for sealing the end of the expansion/contraction body being integrated, the material for the plug and the space reducing body does not have to be limited to rubber.

### Embodiment 4

FIG. 5 is a cross-section showing the fluid pressure type actuator by embodiment 4 of the present invention. In the inner tube 1, a rod-like space reducing body 11 having a cross-sectional circular shape is contained. The space reducing body 11 is separated from the first and the second rubber plugs 2 and 3, and is capable of being displaced in axis direction of the inner tube 1. Also, the space reducing 11 is made from resin such as polyacetal (POM) or polyurethane. The other configuration and operation are the same as embodiment 1.

In this way, the space reducing body 11 that is capable of being displaced in the inner tube may be used, thus the time for raising the pressure in the inner tube 1 can be shortened, whereby speeding up the operation of the actuator.

### Embodiment 5

Next, FIG. 6 is a cross-section showing the fluid pressure type actuator by embodiment 5 of the present invention. In the inner tube 1, a space reducing body 12 is contained. The space reducing body 12 is the space reducing body 11 of embodiment 4 of which the inside is made hollow. The other configuration and operation are the same as embodiment 1. By such configuration, the space reducing body 12 can attain lighter weight, whereby reducing the entire weight of the actuator.

### Embodiment 6

FIG. 7 is a cross-section showing the fluid pressure type actuator by embodiment 6 of the present invention. In the inner tube 1, a space reducing body 13 is contained. The space reducing body 13 is made of soft and flexible resin, and is flexible being integrated with the inner tube 1. The other configuration and operation are the same as embodiment 1. By such configuration, application of the actuator can be expanded without the space reducing body 13 interfering with the flexibility of the entire actuator.

### Embodiment 7

Next, FIG. 8 is a cross-section showing the fluid pressure type actuator by embodiment 7 of the present invention. In the inner tube 1, a space reducing body 14 is contained. The space reducing body 14 is configured by, for example, encapsulating a fluid such as water into a bag. The other configuration and operation are the same as embodiment 1. By such configuration, the space reducing body 14 can be transformed corresponding to the shape transformation of the inner tube 1 due to expansion/contraction, whereby making it possible to fill the space in the inner tube 1 effectively. For example, if measurement of the inner tube 1 in initial state (contracted condition) is set as φ20 mm×300 mm and measurement in expanded condition is set as φ50 mm×210 mm, the respective cubic volumes turn out to be 30πcm³ and 131.25πcm³. By filling approximately all the space in the inner tube 1 in the initial state by the space reducing body 14, compressed fluid necessary for starting-up the actuator to the actual operation can be reduced to approximately zero. In addition, the space reducing body may be a material such as a gelled substance, powder or particles being encapsulated into a bag.

### Embodiment 8

FIG. 9 is a cross-section showing the fluid pressure type actuator by embodiment 8 of the present invention. In the inner tube 1, a number of space reducing bodies 15 are contained which are formed by a particle solid substance having sufficiently smaller diameter than the internal diameter of the inner tube 1. The other configuration and operation are the same as embodiment 1. In this way, the space in the inner tube 1 can be efficiently filled also in the case of using the particle-formed space reducing body 15.

### Embodiment 9

FIG. 10 is a cross-section showing the fluid pressure type actuator by embodiment 9 of the present invention. In the inner tube 1, a space reducing body 11 is contained. In the space between the space reducing body 11 and the inner tube 1, a low friction body 16 wherein the frictional coefficient with respect to the inner tube 1 is smaller than the one of the space reducing body 11, is provided. In this example, the space reducing body 11 is contained in the bursiform low frictional body 16. In other words, the space reducing body 11 is covered by the low friction body 16. As for the material for the low friction body 16, for example, an expansible fabric used for hoses may be used. Also, such fabric is made up of a synthetic fiber that is, for example, a polyurethane core fiber enlaced with nylon fiber. The other configuration and operation are the same as embodiment 1.

By such configuration, upon expanding/contracting the inner tube 1, the inner tube 1 can be protected from being damaged due to a direct contact of the inner tube and the space reducing body 11. In addition, the point that the space reducing body is covered by the low friction body can be applied also to the previously mentioned embodiments 1˜8.

Also, while a pneumatic actuator is illustrated as a fluid pressure type actuator in the above-described examples, the fluid to be supplied to the expansible/contractible body does not have to be limited to air, and a variety of gases or liquids may be used in accordance with the purpose of usage. Further, in the above-examples, while only the elongate tubular actuator is illustrated, a variety of fluid pressure type actuators can be provided through changing the shape of the expansible/contractible body, and the present invention can be applied thereto.

Moreover, the fluid pressure type actuator of the present invention can be used with various medical equipment such as rehabilitation equipment (for example, a CPM device, etc.) and an actuator for devices such as nursing care equipments. Also, it can be used as an actuator for driving a wearable robot for a person to put on that is an artificial muscle. Further, it can be used as an actuator for driving industrial robots or construction equipment. The fluid pressure type actuator of the present invention, therefore, can be applied to all different fields of equipment.

FIG. 11 shows an exercise device to which the fluid actuator described in embodiments 1˜9 is applied. The exercise device 21 on which an arm of a user is to be placed has a first frame body 22, a second frame body 23 relatively revolvable (flexible) with respect to the first frame body 22, and joint portion 24 arranged between the first frame body 22 and the second frame body 23. The first and the second frame bodies 22 and 23 have an exterior material 25 made of cloth and a plurality of air tubes 26 arranged inside of the exterior material 25.

The respective air tubes 26 are made of flexible material such as rubber or vinyl, and arranged parallel with respect to one another. Also, the number of layers to be arranged in the air tubes 26 in the thickness direction of the exercise device 21 gets larger on both of the end portions in the width direction than in the center of the width direction of the exercise device 21. More specifically, the air tubes 26 are arranged in two layers at both ends in the width direction of the exercise device 21, and one layer of air tube 26 is arranged in other places. All of the air tubes 25 are connected to one another by a connecting pipe (not shown in the diagram), and is configured so that air can be supplied/discharged from a common supply port.

The joint 24 has the cloth exterior material 25 and a cushion member 28 filled in the exterior material 25. The cushion member 27 is made of material such as sponge. Upon use, the upper arm of the user is applied on the first frame body 22, the lower arm of the user is applied on the second frame body 23, and the elbow of the user is applied on the joint 24.

The first and the second frame bodies 22 and 23 have a predetermined stiffness when air is supplied into the air tube 26 by a predetermined pressure, and is flexible when the air is discharged from the air tube 26. The predetermined stiffness here means that the rigidity (intensity) which can sufficiently support the weight of a human body part as a driving target, which is the weight of the arm here, and the degree of stiffness wherein the weight can not deform the shape of the body part. In between the first frame body 22 and the second frame body 23, a pair of fluid pressure type actuators 28 is provided as the actuators to generate a driving force for relatively moving the second frame body 23 with respect to the first frame body 22. These fluid pressure type actuators are the ones described in embodiments 1˜9. In concrete terms, the fluid pressure type actuators 28 are arranged on both sides of the width direction of the first and the second frame bodies 22 and 23.

In the fluid pressure type actuator 28, its length contracts/expands according to the supply/discharge of air, and the driving force (tension) is generated upon contraction. One end of the fluid pressure type actuator 28 is fixed to the first frame body 22, and the other end is fixed to the second frame body 23.

To the air tube 26 and the fluid pressure type actuator 28, a transportable control box 29 is connected via a cable 30. In the control box 29, devices such as an air supply unit, a pressure controller, an output selector and a control computer are incorporated.

The air pressure to be supplied to the air tube 26 and the fluid pressure type actuator 28 from the air supply unit or the timing for supplying/discharging the air are controlled by the control computer. In the control computer, one or more operation programs are stored.

The control box 29 variably changes the air pressure to be supplied to the fluid pressure type actuator 28 or the amount of supplying/discharging the air, in accordance with the size of the space reducing body described in the above embodiments. In concrete terms, in embodiment 1, when the entire length of the fluid pressure type actuator contracts by 3 cm due to the expansion of the inner tube 1 and the space between the space reducing body 4 and the space reducing body 5 upon contracted condition of the fluid pressure type actuator is 2.5 cm, the control box 29 variably changes the air pressure or the amount of supplying/discharging air so that the space reducing body 4 and the space reducing body 5 do not touch each other, and that the fluid pressure type actuator contracts within 2.5 cm. Also, the control box 29 sets the air pressure or the amount of the air to be supplied to the plurality of fluid pressure type actuators 28 respectively. In the case that the space reducing bodies being placed in the plurality of fluid pressure type actuators are different, air pressure or the amount of the air to be supplied to the fluid pressure type actuators 28 are variably changed respectively so that the space reducing body 4 and the space reducing body 5 do not touch each other.

As described above, it is possible to speed up the operation of the exercise device 21 by applying the fluid pressure type actuator described in embodiments 1˜9 to the exercise device 21. Also, motor function of the exercise device 21 can be maximized through setting air pressure or the amount of the air to be supplied to the fluid pressure type actuator 28 in the control box 29.

1. A fluid pressure type actuator comprising:
an expansible/contractible body which is sealed by plug members at both ends, and expanded/contacted by the supply/discharge of a fluid thereto/therefrom;
a net-like wrapping body which wraps the outside of the expansible/contractible body, and is fastened and secured to the plug members at both ends;
an inlet/outlet for fluid formed in the plug members, and
a space reducing body for filling at least a part of the space in the expansible/contractible body.

2. The fluid pressure type actuator according to claim 1, wherein:
the space reducing body arranged in the expansible/contractible body is formed by a first space reducing body and a second space reducing body; and
the first space reducing body and the second space reducing body are respectively coupled to the plug members, and are arranged having space between each other in the long-axis direction of the expansible/contractible body.

3. The fluid pressure type actuator according to claim 2, wherein the cross-sectional area of the first space reducing body and the second space reducing body is gradually reduced from the rear anchor toward the end portion.

4. The fluid pressure type actuator according to claim 2, wherein the end portion of the first space reducing body and the second space reducing body is formed having a spherical surface.

5. The fluid pressure type actuator according to claim 2, wherein the length of the expansible/contractible body for expanding/contracting is to be the same as the length of the space between the first space reducing body and the second space reducing body upon expanded condition of the expansible/contractible body.

6. The fluid pressure type actuator according to claim 1, wherein:
the expansible/contractible body has a tubular form;
the end portions of the expansible/contractible body are sealed by a first rubber plug and a second rubber plug; and
the space reducing body is provided being integrated with the first rubber plug or the second rubber plug.

7. The fluid pressure type actuator according to claim 6, wherein the first rubber plug or the second rubber plug has the space reducing body.

8. The fluid pressure type actuator according to claim 6, wherein the space reducing body is decoupled from the first rubber plug or the second rubber plug.

9. The fluid pressure type actuator according to claim 1, wherein the space reducing body is hollow inside.

10. The fluid pressure type actuator according to claim 1, wherein the space reducing body has flexibility, and capable of being curved along with the expansible/contractible body.

11. The fluid pressure type actuator according to claim 1, wherein the space reducing body has a configuration that fluid is being encapsulated into a bag.

12. The fluid pressure type actuator according to claim 1, wherein the space reducing body is a particle solid substance sufficiently smaller than the inner diameter of the expansible/contractible body.

13. The fluid pressure type actuator according to claim 1, characterized in that a low friction body of which the friction coefficient with respect to the expansible/contractible body is smaller than the one of the space reducing body, is provided between the space reducing body and the expansible/contractible body.

14. An exercise device comprising:
a first frame body;
a second frame body revolvable with respect to the first frame body; and
the fluid pressure type actuator which can relatively move the second frame body with respect to the first frame body, and is described in the above-described claims 1˜13,
so as to cause a part of a human body to perform exercise by moving the second frame body with respect to the first frame body.
